(19) United States
(12) Patent Application Publication
(10) Pub. No.: US 2017/0199912 A1
(43) Pub. Date: Jul. 13, 2017

(54) BEHAVIOR TOPIC GRIDS

(71) Applicant: QUALCOMM Incorporated, San Diego, CA (US)

(72) Inventors: Shih-Chieh Su, San Diego, CA (US); Joseph Vaughn, San Diego, CA (US); Jean-Laurent Ngoc Huynh, San Diego, CA (US)

(21) Appl. No.: 14/991,787

(22) Filed: Jan. 8, 2016

(51) Int. Cl. G06F 17/30

(52) U.S. Cl. CPC G06F 17/30528; G06F 17/30339; G06F 17/30368; G06F 17/30327; G06F 17/30551

(57) ABSTRACT

Embodiments relate to a computing device that creates and displays a behavior footprint grid. The computing device may comprise: an interface to receive user log data from another computing device and a processor coupled to the interface. The processor may be configured to: summarize user behavior associated with the user log data received from the another computing device; create a behavior footprint grid based upon the summary of user behavior; and display the behavior footprint grid on a display device.

### BACKGROUND

Field

The present invention relates to a computing device that creates and displays a behavior topic footprint grid.

Relevant Background

Analyzing massive amounts of activity logs can be a labor intensive task for analysis experts. Present analytic tools are used to measure the volume and frequency of activity logs to attempt to determine repeated patterns about a user's behavior for analysis experts.

Analysis experts typically review log items one-by-one, which is a slow method, but is the common methodology used to determine what content a user has been accessing. Organizing the file locations to some certain depth of the path or some keywords can help reduce the effort for the analysis expert. However, this reduction only truncates the information outside of the chosen prefix or keywords, and the items to be reviewed are still overwhelming.

It would be beneficial to abstract and visualize the repository activities of a user (e.g., of a user over a period of time) in a way that an analysis expert can easily perceive.

### SUMMARY

Aspects may relate to a computing device that creates and displays a behavior footprint grid. The computing device may comprise: an interface to receive user log data from another computing device and a processor coupled to the interface. The processor may be configured to: summarize user behavior associated with the user log data received from the another computing device; create a behavior footprint grid based upon the summary of user behavior; and display the behavior footprint grid on a display device.

### BRIEF DESCRIPTION OF THE DRAWINGS

FIG. 1 is a diagram of a computing device with which embodiments may be practiced.

FIG. 2 is a diagram of a process to create and display a behavior footprint grid.

FIG. 3 is a diagram of the output of the MDS 2D behavior topic space.

FIG. 4A is a diagram showing a plurality of topic points spread with the SD spacing algorithm.

FIG. 4B is a diagram showing a plurality of topic points spread with the SD spacing algorithm.

FIG. 5 shows diagrams illustrating behavior footprint grids.

FIG. 6 shows a diagram illustrating behavior footprint grids in a 3D space with time as a factor.

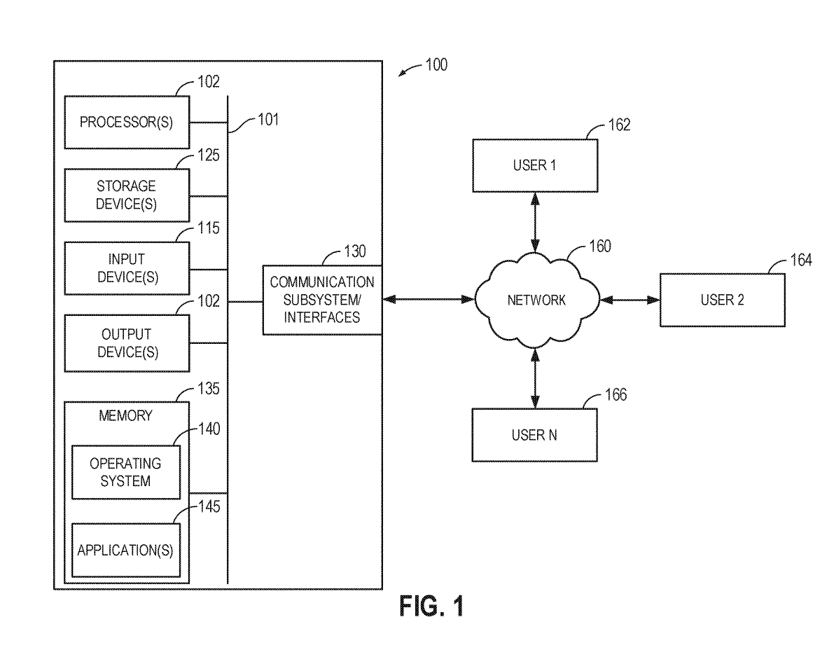

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the terms “device”, “computing system”, or “computing device” may be used interchangeably and may refer to any form of computing device including but not limited to laptop computers, desktop computers, personal computers, servers, tablets, smartphones, televisions, home appliances, cellular telephones, watches, wearable devices, Internet of Things (IoT) devices, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, system on a chip (SoC), or any type of computing device or data processing apparatus.

An example computing device 100 may be in communication with a plurality of other computing devices 162, 164, 166 utilized by Users 1-N, respectively, via a network 160. As an example, computing device 100 may comprise hardware elements that can be electrically coupled via a bus 101 (or may otherwise be in communication, as appropriate). The hardware elements may include one or more processors 102, including without limitation one or more general-purpose processors and/or one or more special-purpose processors (such as digital signal processing chips, graphics acceleration processors, and/or the like); one or more input devices 115 (e.g., keyboard, keypad, touchscreen, mouse, etc.); and one or more output devices 122 (e.g., display device, speaker, printer, etc.). Additionally, computing device 100 may include a wide variety of sensors. Sensors may include: a clock, an ambient light sensor (ALS), a biometric sensor (e.g., blood pressure monitor, etc.), an accelerometer, a gyroscope, a magnetometer, an orientation sensor, a fingerprint sensor, a weather sensor (e.g., temperature, wind, humidity, barometric pressure, etc.), a Global Positioning Sensor (GPS), an infrared (IR) sensor, a proximity sensor, near field communication (NFC) sensor, a microphone, a camera, or any type of sensor.

Computing device 100 may further include (and/or be in communication with) one or more non-transitory storage devices 125, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

Computing device 100 may also include a communication subsystem and/or interface 130, which may include without limitation a modem, a network card (wireless or wired), a wireless communication device and/or chipset (such as a Bluetooth device, an 802.11 device, a Wi-Fi device, a WiMax device, cellular communication devices, etc.), and/or the like. The communications subsystem and/or interfaces 130 may permit data to be exchanged with other computing devices 162, 164, 166 from users (e.g., user 1, user 2, user N) through an appropriate network 160 (wireless and/or wired).

In some embodiments, computing device 100 may further comprise a working memory 135, which can include a RAM or ROM device, as described above. Computing device 100 may include firmware elements, software elements, shown as being currently located within the working memory 135, including an operating system 140, applications 145, device drivers, executable libraries, and/or other code. In one embodiment, an application may be designed to implement methods, and/or configure systems, to implement embodiments, as described herein. Merely by way of example, one or more procedures described with respect to the method(s) discussed below may be implemented as code and/or instructions executable by a device (and/or a processor within a device); in an aspect, then, such code and/or instructions can be used to configure and/or adapt a computing device 100 to perform one or more operations in accordance with the described methods, according to embodiments described herein.

A set of these instructions and/or code may be stored on a non-transitory computer-readable storage medium, such as the storage device(s) 125 described above. In some cases, the storage medium might be incorporated within a computer system, such as computing device 100. In other embodiments, the storage medium might be separate from the devices (e.g., a removable medium, such as a compact disc), and/or provided in an installation package, such that the storage medium can be used to program, configure, and/or adapt a computing device with the instructions/code stored thereon. These instructions might take the form of executable code, which is executable by computing device 100 and/or might take the form of source and/or installable code, which, upon compilation and/or installation on computing device 100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, firmware, software, or combinations thereof, to implement embodiments described herein. Further, connection to other computing devices such as network input/output devices may be employed.

In one embodiment, computing device 100 receives user log data through network 160 from another computing device (e.g., user 1 computing device 162) through interface 130. It should be appreciated that a wide variety of users utilizing computing devices may be monitored for user log data (e.g., user 1 computing device 162; user 2 computing device 164 . . . user N computing device 166). Processor 102 implementing an application 145 may be configured to: summarize user behavior data associated with the user log data received from the other computing device 162 through the interface 130; create a behavior footprint grid based upon the summary of user behavior; and display the behavior footprint grid on the display device 122. In one embodiment, processor 102 may be configured to apply an algorithm to the user log data over a period of time to define a plurality of topics. As one example, the algorithm may be a Latent Dirichlet Allocation (LDA) algorithm, but any suitable algorithm may be utilized. Processor 102 may also be configured to apply an algorithm to the plurality of topics to create a two dimensional (2D) or three dimensional (3D) behavior topic space for the topics, as will be described in more detail hereafter. As one example, the algorithm may be a multi-dimensional scaling (MDS) algorithm, but any suitable method or algorithm may be utilized that may utilize word embedding techniques that can reduce the dimensions of the topics. Additionally, as will be described, processor 102 may be further configured to apply a split-diffuse (SD) algorithm to the 2D or 3D behavior topic space for use in generating a behavior footprint grid. As one example, before applying an LDA type algorithm, a corpus may be formed. For example, starting from the behavior logs, the paths (e.g., directories) and the metadata of the logs may be punctuated into a series of words. The series of words on one log entry may be referred to as a behavior article. The collection of all behavior articles forms the corpus. Thus, computing device 100 may be configured to extract behavior information from the logs to form a corpus and to apply an LDA-like algorithm on the corpus to generate the topics. It should be appreciated that other method or algorithms to generate topics (e.g., from a corpus) may be utilized.

As will be described, embodiments relate to an approach to summarize and visualize user behavior from received user log data into a behavior footprint grid. In particular, user log data over a predetermined period of time is accumulated and words in the user log data are defined and placed into topics via an LDA algorithm or other topic-generating algorithms. In this way, the user log data from user computing device 162 may be mapped into topics dependent upon the words appearing in the logs. As will be described, these topics may be placed into a two dimensional (2D) plane, via a multi-dimensional scaling (MDS) algorithm or other dimension reduction algorithms, where similar topics are close each other. Further, a behavior footprint grid that acts as a heat map type of image may be used to visualize the topics of the content that a user has fetched as identified in the received user log data from the user's computing device 162. It should be appreciated that for a topic point within a densely populated area, the true intensity of a topic may be easily interfered with nearby topics. Accordingly, as will be described, isolated grids may be used to visualize the topics. Further, the property of nearby points representing topics that are close to each other are still maintained. In order to achieve these functions, a split-diffuse (SD) algorithm may be used to distribute the topics evenly over the 2D plane, while keeping their geometry similar.

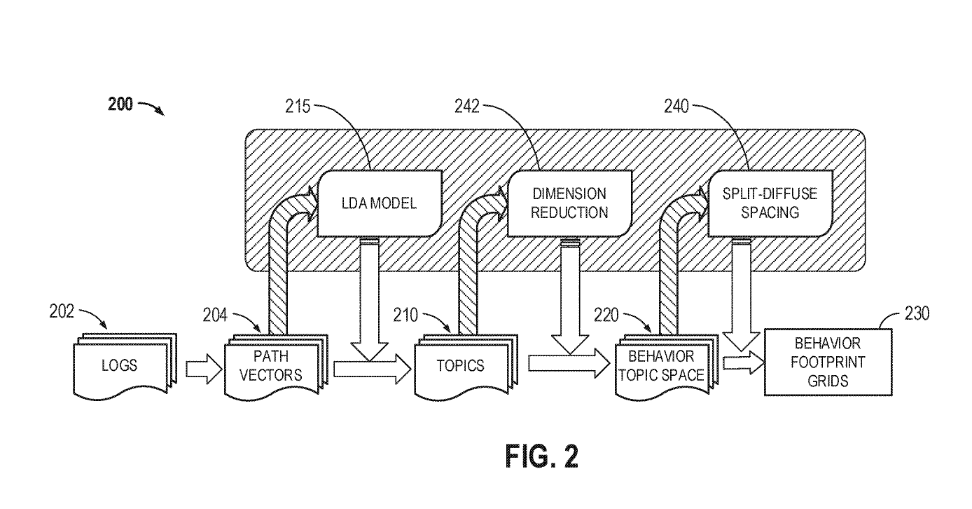

With additional reference to FIG. 2, a process 200 implemented by processor 102 of computing device 100 to create and display a behavior footprint grid on a display device 122 will be described. In one embodiment, a plurality of logs 202 representing user log data from a remote computing device 162 in conjunction with their path vectors 204 may be received and collected by computing device 100. Based upon this received data, topics 210 may be created by computing device 100, by computing device 100 applying a Latent Dirichlet Allocation (LDA) model 215 to the user log data 202 and path vectors 204 over a period of time to define a plurality of topics 210. The topics 210 may further be rendered by computing device 100 in a human-perceivable behavior topic space 220 by applying a dimension reduction algorithm 242 (e.g., a multi-dimensional scaling (MDS) algorithm) to the pluralities of topics 210 to reduce the dimensionality of the topics to a 2D behavior topic space for the topics, as will be described. Further, a split-diffuse (SD) spacing algorithm may be applied to the 2D behavior topic space 220 to create a SD tree, as will be described. The 2D behavior topic space 220 having the SD spacing algorithm 240 being applied to it by may be utilized to create a behavior footprint grid 230 for display by the computing device 100. In particular, as will be described, the behavior footprint grid 230 is created by assigning each topic of the SD tree generated by the SD spacing algorithm to a designated grid of the behavior footprint grid for display by the computing device 100.

In one embodiment, process 200 to create the behavior foot grids 230 may be trained. As an example, slashed arrows to the LDA model 215, dimension reduction algorithm 242, and split-diffuse (SD) spacing algorithm 240 (in the slashed block) illustrate aspects of the process that may be trained. For example, the LDA model 215, dimension reduction algorithm 242, and split-diffuse (SD) spacing algorithm 240 may be initially trained based upon data over a predefined period of time (e.g., 1 month, 3 months, 6 months, etc.) (i.e., any suitable period of time). Based upon this inputted data (e.g., user log data 202) for the predefined period of time, the models and mappings (e.g., LDA model 215, dimension reduction algorithm 242, and SD spacing algorithm 240) are trained. Once these models and mappings are trained, their parameters may be fixed until they are re-trained after a pre-defined period of time (e.g., 1 month, 3 months, 6 months, etc.) (i.e., any suitable period of time). Based upon this training, all current, future, and historical behavior data (e.g., user log data 204), go thru the trained LDA model 215, trained dimension reduction algorithm 242, and trained SD spacing algorithm 240 to generate behavior footprint grids 230, as previously described. More particular descriptions of these components will be hereafter described.

Looking at a particular implementations, the behavior footprint grid 230, as will be described in more detail hereafter, may be considered to be a heat map type of image that is used to visualize the kinds of content that the user has fetched, referred to as topics 210. Topics may refer to user log data and path vectors that indicate access to directories, folders, documents, file names, etc. As an example, a path vector to get to a file name through a plurality of directories or folders may be: corporation name/department name/team name/individual name/project name/directory name/file name Of course, this is merely an example of a path vector and log data, and any sort of path vector/log data, etc., may be utilized.

In any event, the behavior footprint grid 230 may be designed in accordance with the following factors: 1) a normal user typically interacts with only one or a few topics; 2) a topic is typically only covered by one or a few group of users; 3) topics close to each other in a vector space should typically be close to each other on the behavior footprint grid 230; and 4) normal users in the same group typically have similar behavior footprint grids 230.

Also, it should be noted that, as to the topics 210 process step, in the original format after having the LDA model 215 applied to the user log data over a period of time to define the topics 210, the topics 210 may be represented in a very high dimensional space (roughly the size of a vocabulary presented in the path vectors 204). As an example to use word embedding techniques to map the topics 210 into a 2D behavior topic space 220, we apply a dimension reduction algorithm 242 (e.g., a MDS algorithm) to the topics 210. In this way, topics close to each other in the vector space are close to each in the 2D behavior topic space 220 and the behavior footprint grid 230.

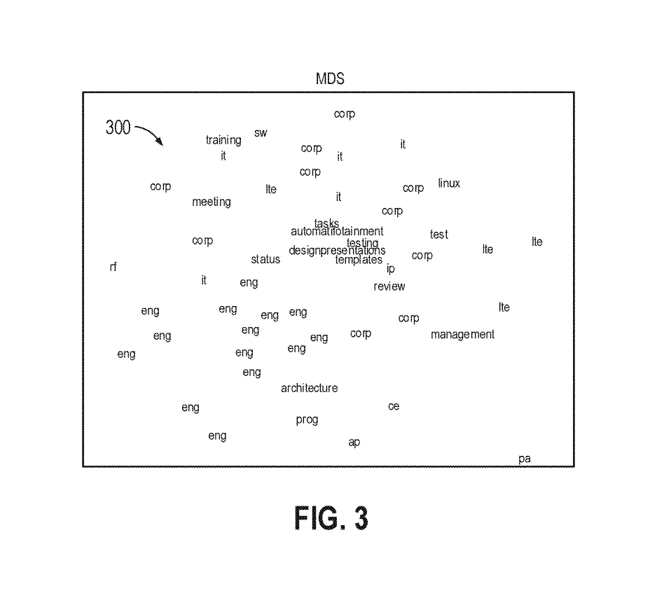

With additional reference to FIG. 3, the output of the MDS 2D behavior topic space 220 is illustrated. As can be seen in example illustration 300, there are a wide variety of topics. As examples, topic directories for corporation (e.g., CORP) referring to the corporation name is quite common for the user. Also, in this example, the directory for the engineering group (e.g., ENG) is also very common for the user. As an example, the user may be an employee of the corporation and is in the engineering group through which directories the user goes to access information. Further, many other types of directories are utilized but less common such as: training; SW (e.g., software); IT (e.g., information technology); meeting; architecture; tasks; management; RF (e.g., radio frequency group); PROG (e.g., programming group) . . . etc. It should be appreciated that the user typically goes through their corporation directory to their engineering directory for common access but also may access other items such as their IT group, training group, software group, etc., as is typical of most corporate employees. As one example, the MDS 2D behavior topic space 220 may be time based such that during the course of a day, the user may continuously access similar directories (e.g., ENG, CORP, etc.). On other days, various uncommon directories may be accessed very quickly and overlap (e.g., tasks, automation, entertainments, testing, design, presentations, templates, etc.) It should be appreciated that, in one embodiment, one dimension (e.g., x-axis) may be reserved for topics and another dimension (e.g., y-axis) may be reserved for time (e.g., day, hour, etc.). In one embodiment, as will be described hereafter a z-axis, for time, in a 3D implementation will be described. It should be noted that the MDS algorithm to create the 2D behavior topic space 220, shown as illustration 300, keeps the topology of the points of the original high dimensional space of the LDA model 215 of topics. Therefore, two points that are close to each other in the original space should be close to each other in the output of the 2D behavior space 220. Also it should be appreciated that when disclosed externally the wording of: CORP, ENG; tasks; etc.; may be illustrated in a scrambled and encrypted form for security reasons.

Thus, the behavior topic space 220 shown in FIG. 3, as example illustrations 300, is utilized to present the user's behavior on this projected MDS plane. However, the topics are often scattered unevenly on the 2D MDS space. For a topic point within a densely populated area, the true intensity of a topic can be easily interfered with by nearby topics. Therefore, isolated grids may be used to better visualize the topics. However, at the same time, the beneficial properties of utilizing the MDS, which represent nearby topics that are close to each other, should also be maintained.

In one embodiment, to better render the behavior topics as part of a behavior footprint grid 230, a split-diffuse (SD) spacing algorithm 240 may be utilized. Utilizing the SD spacing algorithm 240 topics may be evenly distributed in both dimensions while keeping similarity to the geometry of the MDS layout. Thus, a split-diffuse (SD) spacing algorithm 240 may be utilized.

An example of this SD spacing algorithm 240 is represented below:

split-diffuse(points *p, depth)

k ← length of p
if k≦1, return p
a ← mod(depth, 2)
m ← median of p in the dimension a
return (split=m,

split-diffuse({p:p ≦ m|_{dimension=a}}, depth+1),
split-diffuse({p:p > m|_{dimension=a}}, depth+1))

As shown, the SD spacing algorithm 240 by calling the split-diffuse function with a list of topic points (p) in 2D space and a depth of 0 actually constructs a tree, hereafter termed the SD tree. The SD algorithm looks for densely populated areas in a region of interest, and splits the region into two with an equal number of points. By doing so iteratively in the x-direction and y-direction, the topic points in the densely area may be moved (e.g. diffused) towards the sparse area, thereby achieving the benefit of making the topic points distributed evenly in both directions. It should be appreciated that in a 2D implementation that in line: a ←mod(depth, 2); of the above algorithm, that the value is set 2. However, if the MDS (or other dimension reduction algorithm) reduces topics to a 3D space a value of 3 would be set. An example of this will be described with a 3D implementation to be hereafter described.

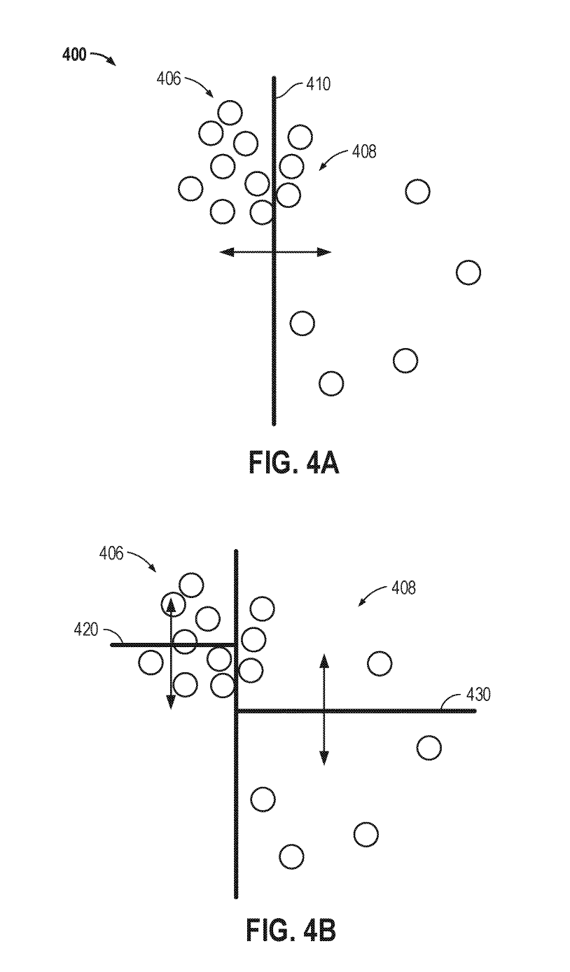

An example of the SD spacing algorithm may be illustrated with reference to FIGS. 4A and 4B. As shown in FIG. 4A, a plurality of topic points 400 are shown. To begin with, the SD spacing algorithm may split some of the topic points 400 in the x-direction based upon line 410 into points 406 and points 408. Further, as shown in FIG. 4B, the SD spacing algorithm may further split points 406 in the y-direction along line 420 and points 408 in the y-direction along line 430. In this way, the SD spacing algorithm may be applied iteratively in the x-direction and the y-direction to distribute topic points in the SD tree evenly in the x-direction and the y-direction. After constructing the SD tree, as shown in FIGS. 4A and 4B, each point, representative of a topic (i.e., a topic point) may then be assigned to a designated grid of the final behavior footprint grid 230. It should be appreciated that by performing this process iteratively in the x and y directions, the topic points in the densely populated area will be moved (diffused) toward the sparse area, thus achieving the goal of evenly distributed topic points. The split at the medium point also guarantees the grids from the split-diffuse algorithm will satisfy at least half of the geometric conditions in the original space. Thus, the SD algorithm builds a tree data structure, namely the SD tree, to provide the uniformly distributed topic point layout.

Various illustrations of outputted behavior footprint grids will be hereinafter described.

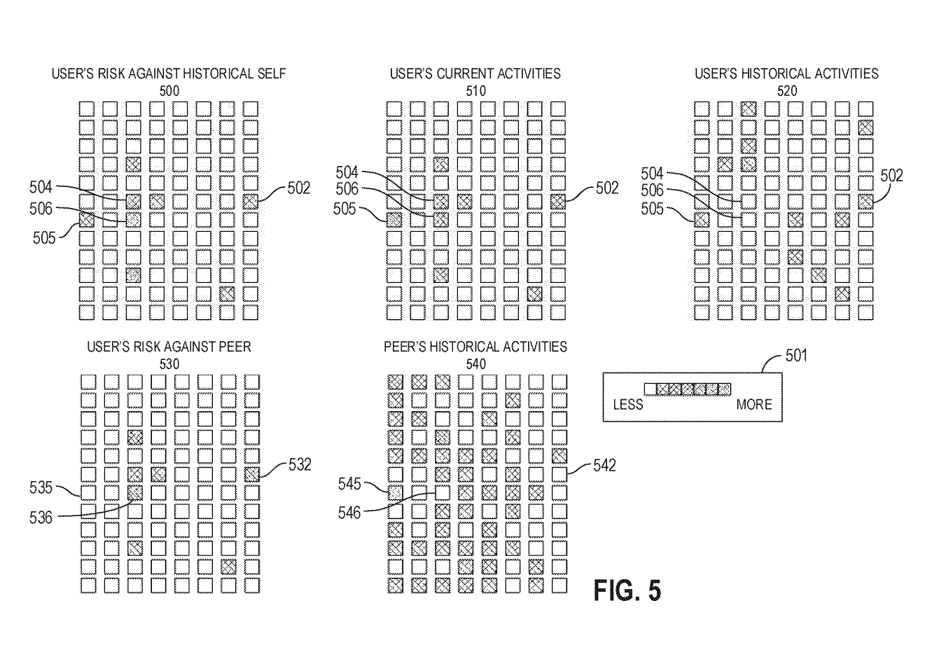

For example, FIG. 5 illustrates behavior footprint grids that demonstrate the behavior of a user, peers, and risks of user against themselves and peers. To begin with, graph 501 illustrates identifiers that are used for topic blocks that indicate the amount of use of the topic: least amount of use (none/blank) to more (e.g., a great deal of use). Comparisons of the topic blocks indicating the amount of use of the topics can be indicative of risk, as will be described.

As an example, a user's risk against their historical self behavior footprint grid 500 may be generated. To achieve this, first a user's current behavior footprint grid 510 is generated for a predetermined period of time, as previously described, by utilizing the SD algorithm to assign each topic of the SD tree to a designated grid block of the user's current behavior footprint grid 510. As can be seen in this example, grid block 502 designating the corporation topic is commonly utilized. Further, grid block 505 designating the engineering topic is frequently utilized. Grid block 504 designating the management topic is regularly accessed. Also, the grid block 506 designating the architecture topic is regularly accessed. It should be appreciated that a lot of the topics are never accessed such that their grid blocks are blank. Also, other topics are accessed by an amount as indicated by the use designation in their grid, but are not particularly described for brevity's sake.

In order to generate the user's risk against their historical self behavior footprint grid 500, the user's historical activities need to be identified. This historical activity may be for any suitable predetermined period of time, e.g., 2 weeks, 1 month, 6 months, 1 year, etc., whereas the user's current activities may set for suitable predetermined period of time, e.g., 1 hour, 4 hours, 1 day, 3 days, 1 week, 1 month, etc. To achieve this, a user's historical activity behavior footprint grid 520 is generated for a predetermined period of time, as previously described, by utilizing the SD algorithm to assign each topic of the SD tree to a designated grid block of the user's historical activity behavior footprint grid 520. As can be seen in this example, grid block 502 designating the corporation topic is commonly utilized. Further, grid block 505 designating the engineering topic is frequently utilized. Grid block 504 designating the management topic is never accessed. Also, the grid block 506 designating the architecture topic is never accessed.

In order to generate the user's risk against their historical self behavior footprint grid 500, the user's current behavior footprint grid 510 is compared against the user's historical activity behavior footprint grid 520. Based upon this comparison, the user's risk against their historical self behavior footprint grid 500 shows that grid block 502 designating the corporation topic shows that the comparison remains relatively low, there is a slight difference that could be looked at. This would be logical as the user commonly accesses the corporation folder. Further, grid block 505 designating the engineering topic shows that the comparison remains relatively low. This would be logical as the user commonly accesses the engineering folder as the user is part of the engineering group, there is a slight difference that could be looked at. However, grid block 504 designating the management topic is shown as having a large difference because under the user's current activity 510 it is frequently accessed, whereas in the user's historical activity 520 it was never accessed. This is indicative of a great risk that the user may be accessing management topic folders and information that there is no apparent reason for the user to be accessing. Moreover, grid block 506 designating the architecture topic is shown as having a large difference because under the user's current activity 510 it is frequently accessed, whereas in the user's historical activity 520 it was never accessed. This is indicative of a great risk that the user may be accessing architecture topic folders and information that there is no apparent reason for the user to be accessing, as they are not part of the architecture group.

As another example, a user's risk against their peers behavior footprint grid 530 may be generated. To achieve this, first a user's current behavior footprint grid 510 is generated for a predetermined period of time, as previously described, by utilizing the SD algorithm to assign each topic of the SD tree to a designated grid block of the user's current behavior footprint grid 510. As can be seen in this example, grid block 505 designating the engineering topic is very frequently utilized. Also, the grid block 506 designating the architecture topic is regularly accessed.

Next, a peer's historical activity behavior footprint grid 540 is generated for a predetermined period of time, as previously described, by utilizing the SD algorithm to assign each topic of the SD tree to a designated grid block of the peer's historical activity behavior footprint grid 540. As can be seen in this example, grid block 545 designating the engineering topic is very frequently utilized. Also, the grid block 546 designating the architecture topic is never accessed.

In order to generate the user's risk against their peers behavior footprint grid 530, the user's current behavior footprint grid 510 is compared against the peer's historical activity behavior footprint grid 540. Based upon this comparison, the user's risk against their peers behavior footprint grid 530 shows that grid block 535 designating the engineering topic shows that the comparison remains relatively low. This would be logical as the user and the user's peers commonly accesses the engineering folder as the user and the user's peers are part of the engineering group. However, grid block 536 designating the architecture topic is shown as having a large difference because under the user's current activity 510 it is frequently accessed, whereas in the peer historical activity 540 at block 546 it was never accessed. This is indicative of a great risk that the user may be accessing architecture topic folders and information that there is no apparent reason for the user to be accessing as the user and the user's peers are not part of the architecture group.

It should be appreciated that this generation of the user's risk against their historical self behavior footprint grid 500 and user's risk against their peers behavior footprint grid 530 are merely examples of the way that these type of risk behavior footprint grids may be generated and displayed to an expert to look at the potential access risks to topics by of a user.

It should be appreciated that the behavior footprint grids of FIG. 5 illustrating the behavior of the user, the peers, and the users risk against self and peers may be displayed on an output display device 122 of a computing device 100 for a security expert to look at. The grids may be displayed on the display device as a user interface, a table, etc. Further, as shown in these examples, the intensity (e.g. heat) of the behavior footprint grids reflect the volumes of the topics and the risks for accessing the topic or any metric about the topic. Also the behavior can be generated for single users or groups.

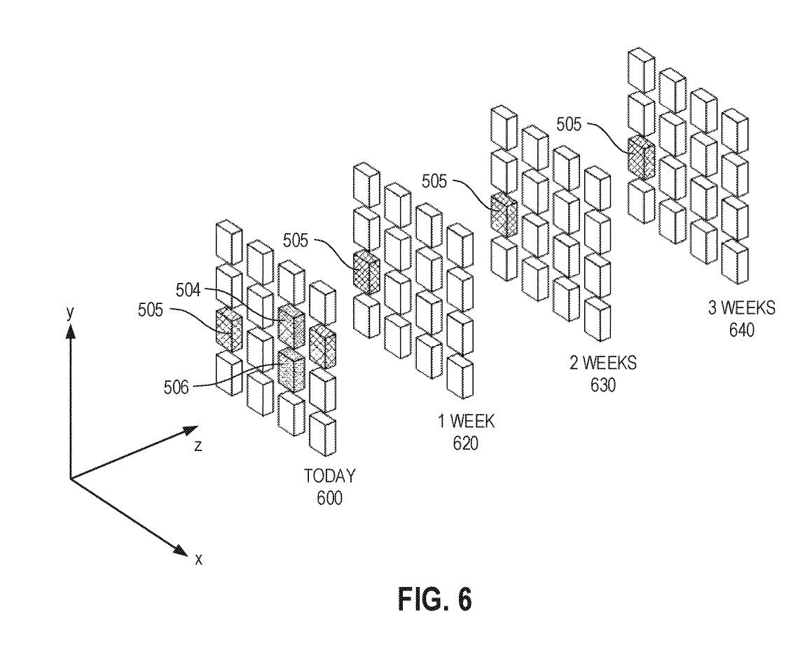

In an additional embodiment, with reference to FIG. 6, a time based 3D behavior footprint grid with footprint cubes may be utilized. In this example, the cubes show the activities for topics (x,y) over time Z. An example will be provided to show the generation of a present user's risk against their historical self behavior footprint 3D cube grid 600 (e.g., Today), in which the user's current activity footprint grid (e.g., user's current activity 510 from FIG. 5) is compared against the user's historical activity behavior footprint 3D cube grids 620, 630, and 640 (which may be similar to the user's historical activities 520 of FIG. 5) to generate the present user's risk against historical self footprint 3D cube grid 600. To achieve this, a multiple amount of previous user's historical activity behavior footprint 3D cube grids 620, 630, and 640 (e.g., for 1 week ago, 2 weeks ago, and 3 weeks ago) are generated. In this example, the previous 3D cube grids 620, 630, and 640, are similar in that grid block cubes 505 designating the engineering topic are frequently utilized whereas the grid blocks 504 designating the management topic are never accessed and grid blocks 506 designating the architecture topic are never accessed (see matching grid block in 600 for numbering comparisons). Based upon this comparison, the user's risk against their historical self behavior footprint 3D cube grid 600 shows that grid cube block 505 designating the engineering topic shows that the comparison remains relatively low. This would be logical as the user commonly accesses the engineering folder as the user is part of the engineering group, and there may be a slight difference that could be looked at. However, grid block 504 designating the management topic in the 3D cube grid 600 is shown as having a large difference because under the user's current activity it is frequently accessed, whereas in the user's past historical activity (3D cube grids 620, 630, 640) it was never accessed. This is indicative of a great risk that the user may be accessing management topic folders and information that there is no apparent reason for the user to be accessing. Moreover, grid block 506 designating the architecture topic in the 3D cube grid 600 is shown as having a large difference because under the user's current activity it is frequently accessed, whereas in the user's past historical activity (3D cube grids 620, 630, 640) it was never accessed. This is indicative of a great risk that the user may be accessing architecture topic folders and information that there is no apparent reason for the user to be accessing, as they are not part of the architecture group.

Therefore, as previously described, time based 3D behavior footprint grids with footprint cubes may be utilized. It should be appreciated that the behavior footprint cube grids of FIG. 6 may be used similar to the examples of FIG. 5, but in 3D, to better exemplify time frames, and to be used to illustrate the behavior of the user, the peers, and the users risk against self and peers. The 3D implementation is very suitable for display on an output display device 122 of a computing device 100 for a security expert to look at. In a particular example, the 3D implementation is suitable for display by virtual reality devices or augmented reality devices.

The behavior footprint visualization can be applied to many domains, as long as the source is the behavioral data in that domain. Examples of use cases may be: Information security domain based on repository log data, e.g., visualizing the topics covering the file/path that the user has accessed; E-commerce marketing domain based on page view data, e.g., visualizing the user's browsing and shopping patterns; Customer service domain based upon input complaints, e.g., visualizing the topics covering the text of the user complained about; Q&A domain based upon the input answers (e.g., visualizing the topic expertise for a user).

Further, in the cyber security domain, the close framework helps to abstract user behavior into easily understandable footprint images to: detect anomalies by comparing to peers and historical footprints; quickly observe the areas that potential data loss may occur; evaluate performance; categorize job functions; etc.

Thus, feature of the behavior footprint image provide an easy way for a security expert or other personnel to visual the behavior of a user based upon the log activities. The previously described behavior footprint grids provide an easy way for a security expert to look at and perceive them. Additionally, all of the topics are easily distributed in both the x dimension and the y dimension. This framework attempts to follow the original topic topology in the original log activity space, such that, close topics are close in the grid.

It should be appreciated that aspects of the previously described processes may be implemented in conjunction with the execution of instructions by a processor (e.g., processor 102) of a devices (e.g., computing device 100), as previously described. Particularly, circuitry of the devices, including but not limited to processors, may operate under the control of a program, routine, or the execution of instructions to execute methods or processes in accordance with embodiments described (e.g., the processes and functions of FIGS. 2-6). For example, such a program may be implemented in firmware or software (e.g. stored in memory and/or other locations) and may be implemented by processors and/or other circuitry of the devices. Further, it should be appreciated that the terms device, processor, microprocessor, circuitry, controller, SoC, etc., refer to any type of logic or circuitry capable of executing logic, commands, instructions, software, firmware, functionality, etc.

It should be appreciated that when the devices are wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, 5G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., communication subsystems/interfaces (e.g., air interfaces)) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a virtual reality or augmented reality device, a personal data assistant (“PDA”), a tablet, a wearable device, an Internet of Things (IoT) device, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other type of computing device. These devices may have different power and data requirements.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a WiFi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations of both. To clearly illustrate this interchangeability of hardware, firmware, or software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA), a system on a chip (SoC), or other programmable logic device, discrete gate or transistor logic, discrete hardware components, or any combination thereof designed to perform the functions described herein. A general purpose processor may be a microprocessor or may be any type of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in firmware, in a software module executed by a processor, or in a combination thereof. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computing device comprising:
an interface to receive user log data from another computing device; and
a processor coupled to the interface, the processor configured to:
summarize user behavior associated with the user log data received from the another computing device;
create a behavior footprint grid based upon the summary of user behavior; and
display the behavior footprint grid on a display device.

2. The computing device of claim 1, wherein the processor is further configured to apply an algorithm to the user log data over a period of time to define a plurality of topics.

3. The computing device of claim 2, wherein the processor is further configured to apply an algorithm to the plurality of topics to create a two dimensional or three dimensional behavior topic space for the topics.

4. The computing device of claim 3, wherein the processor is further configured to apply a split-diffuse (SD) algorithm to the two dimensional behavior topic space to create an SD tree.

5. The computing device of claim 4, wherein the SD algorithm is applied iteratively in an x-direction and a y-direction to distribute points in the SD tree evenly in the x-direction and the y-direction.

6. The computing device of claim 4, wherein the processor is further configured to create the behavior footprint grid by assigning each topic of the SD tree to a designated grid of the behavior footprint grid.

7. The computing device of claim 6, wherein the processor is further configured to create a current use behavior footprint grid for a user for a predetermined period of time.

8. The computing device of claim 7, wherein the processor is further configured to create a user risk against historical self behavior footprint grid for a user as a comparison of the current use versus user historical activity.

9. The computing device of claim 7, wherein the processor is further configured to create a user risk against peer behavior footprint grid for a user as a comparison of current use versus peer historic activity.

10. The computing device of claim 1, wherein the user log data includes at least one of a directory or file name.

11. A method comprising:
receiving user log data from a computing device;
summarizing user behavior associated with the user log data received from the computing device;
creating a behavior footprint grid based upon the summary of user behavior; and
displaying the behavior footprint grid on a display device.

12. The method of claim 11, further comprising applying an algorithm to the user log data over a period of time to define a plurality of topics.

13. The method of claim 12, further comprising applying an algorithm to the plurality of topics to create a two dimensional or three dimensional behavior topic space for the topics.

14. The method of claim 13, further comprising applying a split-diffuse (SD) algorithm to the two dimensional behavior topic space to create an SD tree.

15. The method of claim 14, wherein the SD algorithm is applied iteratively in an x-direction and a y-direction to distribute points in the SD tree evenly in the x-direction and the y-direction.

16. The method of claim 14, further comprising creating the behavior footprint grid by assigning each topic of the SD tree to a designated grid of the behavior footprint grid.

17. The method of claim 16, further comprising creating a current use behavior footprint grid for a user for a predetermined period of time.

18. The method of claim 17, further comprising creating a user risk against historical self behavior footprint grid for a user as a comparison of the current use versus user historical activity.

19. The method of claim 17, further comprising creating a user risk against peer behavior footprint grid for a user as a comparison of current use versus peer historic activity.

20. A non-transitory computer-readable medium including code that, when executed by a processor of a computing device, causes the processor to:
receive user log data from a computing device;
summarize user behavior associated with the user log data received from the computing device;
create a behavior footprint grid based upon the summary of user behavior; and
display the behavior footprint grid on a display device.

21. The computer-readable medium of claim 20, further comprising code to apply an algorithm to the user log data over a period of time to define a plurality of topics.

22. The computer-readable medium of claim 21, further comprising code to apply an algorithm to the plurality of topics to create a two dimensional or three dimensional behavior topic space for the topics.

23. The computer-readable medium of claim 22, further comprising code to create the behavior footprint grid by assigning each topic of a split-diffuse (SD) tree to a designated grid of the behavior footprint grid.

24. The computer-readable medium of claim 23, further comprising code to create a current use behavior footprint grid for a user for a predetermined period of time.

25. The computer-readable medium of claim 24, further comprising code to create a user risk against historical self behavior footprint grid for a user as a comparison of the current use versus user historical activity.

26. The computer-readable medium of claim 24, further comprising code to create a user risk against peer behavior footprint grid for a user as a comparison of current use versus peer historic activity.

27. A computing device comprising:
means for receiving user log data from another computing device; and
means for summarizing user behavior associated with the user log data received from the another computing device;
means for creating a behavior footprint grid based upon the summary of user behavior; and
means for displaying the behavior footprint grid on a display device.

28. The computing device of claim 27, further comprising means for applying an algorithm to the user log data over a period of time to define a plurality of topics.

29. The computing device of claim 28, further comprising means for applying an algorithm to the plurality of topics to create a two dimensional or three dimensional behavior topic space for the topics.

30. The computing device of claim 29, further comprising means for applying a split-diffuse (SD) algorithm to the two dimensional behavior topic space to create an SD tree.
